(19) United States
(12) Patent Application Publication
(10) Pub. No.: US 2008/0046873 A1
(43) Pub. Date: Feb. 21, 2008

(54) METHOD AND SYSTEM FOR PROVIDING DYNAMICALLY CONFIGURABLE AND EXTENSIBLE CONTROL OF ELECTRONIC DEVICES

(76) Inventor: James K. Rumsey, Columbus, IN (US)

Correspondence Address: McGUINNESS & MANARAS LLP, 125 NAGOG PARK, ACTON, MA, 01720, US

(21) Appl. No.: 11/465,253

(22) Filed: Aug. 17, 2006

(51) Int. Cl. G06F 9/45

(52) U.S. Cl. 717/143

(57) ABSTRACT

A new method and system for providing dynamically configurable and extensible control of electronic devices. Text configuration files are used to generate a command tree that is used by command line interface logic to process input words from a user in order to generate output function calls. The text configuration files include master text configuration files that are user independent, and that reflect the functional capabilities of an control system. The text configuration files further include user specific text configuration files that indicate which devices an associated user uses, the commands associated with those devices that are used by that user, and the order in which those devices and commands are presented to the user in a user interface of the control system. The master text configuration files are used to generate a master command tree, and the user specific text configuration files are used to generate an operative command tree. A logical “AND” operation is performed on the master command tree and the operative command tree to form an actual command tree that is used to present user interface options to a user, and to process user inputs. The actual command tree thus will include only commands that are supported by the control system and that are used by the user, in the order defined by the user.

### FIELD OF THE INVENTION

The present invention relates generally to controlling electronic devices, and more specifically to a method and system for providing dynamically configurable and extensible control of electronic devices.

### BACKGROUND OF THE INVENTION

Human beings today need to control a wide variety of electronic devices, which are found in increasing numbers in many living environments, as well as in many work environments. To address this increased complexity, many different device users desire some kind of automated assistance.

For example, people have disabilities making it difficult or impossible for them to control aspects of their physical living environment in the same ways that ordinary people can. A disabled person may not easily be able to control various living environment devices, such as clocks, phones, beds, televisions, doors, lights, elevators, VCRs, DVD players, digital video recorders, CD players, cable television boxes, tape players, stereo systems, satellite television boxes, radios, fans, thermostats, doors, windows, microwave ovens, and others. To address this need, assistive devices, referred to herein for purposes of explanation as environmental control units (“ECUs”), have been developed. An increasing number of people rely on ECUs to control aspects of their living environment on a day to day basis.

Persons that are not disabled also desire assistance in controlling electronic devices in their living and/or work environments. For example, this need is apparent in the area of controlling complex home entertainment systems, which may include significant numbers of independently controllable electronic devices, such as televisions, amplifiers, CD players, DVD players, tape players, pre-amplifiers, sound processors, etc. Such devices may be provided by different manufacturers, and may respond to different remote control commands and/or protocols, making it challenging to centralize control over an entire entertainment system. To address this need, a number of companies have developed computer based solutions in this area.

An effective solution to these problems should include flexibility with regard to adding and/or removing devices and/or commands with respect to a user interface through which the various devices are controlled. Such flexibility should advantageously include the following features:

1. The ability to selectively turn off user interface commands relating to a device. For example, the system should enable a user to turn off all commands relating to a television, VCR, or other specific type of device.

2. The ability to turn off individual user interface commands. For example, if a user only needs ON and OFF commands for a television because channel changing commands are all performed through a cable box, then the system should enable a user to turn off all other commands for the television except for ON and OFF.

3. The ability to re-order the presentation of commands in the user interface. For example, a user may want the command “VCR Channel_Up” to be the first command made available within a set of related device commands. This is especially desirable when a disabled user selects commands using a two position switch, such as a sip/puff, pressure plate, and/or other type of two position switch. By re-ordering commands, the user can organize menu options in a way that reduces the number of switch actions needed to traverse a menu in order to select a frequently used command more easily.

4. The ability to re-order the presentation of devices for selection by the user interface. As with re-ordering of commands, a user may wish to change the order in which devices are presented for selection by the user interface. Again, switch users especially may desire that the order in which devices are presented be conveniently controllable.

5. The ability to dynamically add a new menu or command corresponding to a new device to the user interface. For example, when a new device becomes available, a user may want to control it. However, program logic for controlling that device may not have been originally developed or provided to the user. For example, supporting the new device may require that a series of infrared commands be learned by the controlling device, and a new menu added to the controlling device's user interface. A new remote controlled toaster might be controlled by three infrared commands: 1) toast, 2) lighter, and 3) darker. A new menu in the controlling device user interface would be required that enables selection of the toaster for control, and then selection from among the three possible toaster commands. Adding such new commands and associated user interface menus should be convenient, and not require loading a completely new executable image of operational software onto the controlling device.

While the above features 1 and 2 could potentially be provided by associating enable bits or flags with individual user interface components for individual devices and commands, such an approach is not sufficient to adequately support features 3 through 5.

For the above reasons and others, it would be desirable to have a new system for providing dynamically configurable and extensible user control of multiple electronic devices.

### SUMMARY OF THE INVENTION

In order to address the above described and other shortcomings of prior solutions, a new method and system for providing dynamically configurable and extensible control of electronic devices. In the disclosed system, text configuration files are used to generate a command tree that is used by command line interface logic to process input words from a user in order to generate output function calls. The text configuration files include master text configuration files that are user independent, and that reflect the functional capabilities of an control system. For example, the functional capabilities of an control system may include the device interfaces and associated program code that it currently includes. The text configuration files further include user specific text configuration files. The user specific text configuration files indicate which devices an associated user uses, the commands associated with those devices that are used by that user, and the order in which those commands are presented to the user in a user interface of the control system.

The master text configuration files are used to generate a master command tree, and the user specific text configuration files are used to generate an operative command tree. The disclosed system performs a logical “AND” of the master command tree and the operative command tree to form an actual command tree that is used to present user interface options to a user, and to process user inputs. The actual command tree thus will include only commands that are supported by the control system and that are used by the user, in the order defined by the user.

The input words are received by the command line interface logic from input processing logic that receives inputs from a number of input devices. The input processing logic is divided into separate logic blocks, each of which corresponds to a type or “class” of input devices. Similarly, the output function calls are passed to output processing logic that generates outputs to a number of output devices. The output processing logic is also divided into separate logic blocks, each of which corresponds to a type or “class” of output devices.

The user specific text configuration files indicates the set of input words to be recognized by the input processing logic, for example by way of speech commands issued by the user. The user specific text configuration files further indicates the set of function calls to be recognized by the output processing logic and converted to outputs for the devices controlled by the control system.

Thus there are disclosed a new method and system for providing dynamically configurable and extensible control of electronic devices. The disclosed system advantageously enables a user to selectively turn off user interface commands, turn off individual user interface commands, re-order the presentation of commands in the user interface, re-order the presentation of devices for selection in the user interface, and/or dynamically add a new menu or user interface commands corresponding to a new device.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components in an operational environment of an illustrative embodiment;

FIG. 2 is a block diagram showing an illustrative embodiment of the disclosed text configuration files;

FIG. 3 is a block diagram showing the logical design of an illustrative embodiment of command line interface software logic;

FIG. 4 shows an example of a command tree for processing received commands in an illustrative embodiment;

FIG. 5 is a flow chart showing steps performed in an illustrative embodiment;

FIG. 6 shows an exemplary format for a line of the text configuration files of FIG. 1;

FIGS. 7-18 are command tree diagrams showing an example of a master command tree being constructed using an illustrative embodiment;

FIG. 19 shows an example of an operative command tree generated in an illustrative embodiment; and

FIG. 20 shows an example of an actual command tree in an embodiment of the disclosed system, resulting from a logical “AND” performed on the master command tree of FIG. 18 and the operative command tree of FIG. 19.

### DETAILED DESCRIPTION OF EXEMPLARY EMBODIMENTS

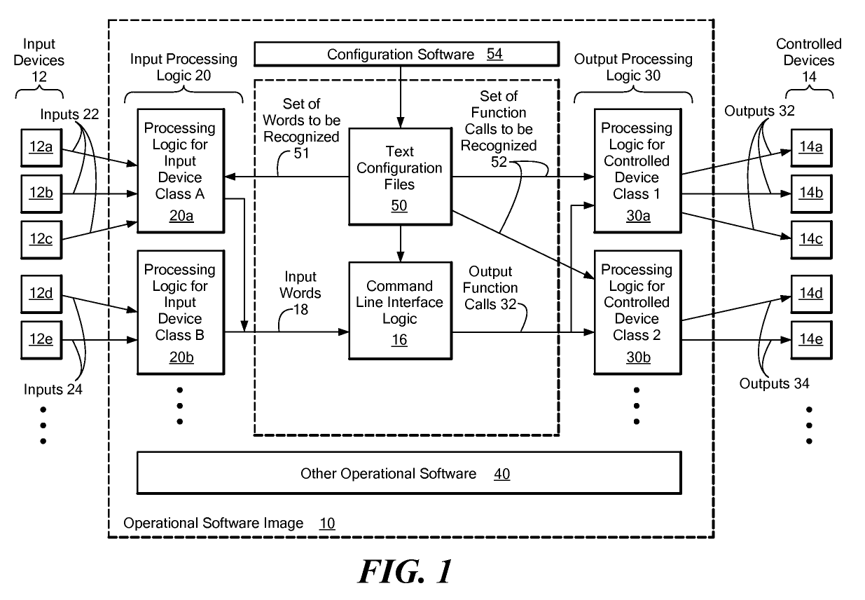

As shown in FIG. 1, components in an operational environment for an illustrative embodiment of the disclosed system include a number of input devices 12. The input devices 12 may include, for example, microphones, switches, RS-232 serial terminals, FM transmitters/receivers, voice over IP interfaces, and/or any other specific type of user input device. The input devices 12 provide inputs to input processing logic 20. The input processing logic 20 is organized into processing logic blocks corresponding to classes of input devices. For example, processing logic 20a for input device class A operates to process input signals received from one class of input devices, while processing logic 20b for input device class B processes input signals received from another, different class of input devices. The input devices within an input device class all provide the same type or kind of input signal, and/or operate using the same communication protocol. For example, a microphone input device and an FM radio receiver could be included within a class of input devices, since they both provide an analog speech input that is fed into the input processing logic 20. In such an embodiment, where input device 12a is a microphone, and input device 12b is an FM radio receiver, then inputs 22 would include analog speech that is fed into processing logic 20a for input device class A. Processing logic 20a would accordingly include a voice recognition processor for converting the analog speech within inputs 22 into digital text. In the example of FIG. 1, since input device 12c also belongs to input device class A, it would similarly provide analog speech within inputs 22 to the processing logic 20a.

Another example of an input device class might consist of switch devices, such as sip/puff, pressure plate, and/or other specific types of accessories used to control two position switches, and that can conveniently be operated, for example, by a disabled person. In such an embodiment, input devices 12d and 12e would be user operated switches, providing “on” and “off” inputs 24 that are converted to text commands by the processing logic 20b for input device class B.

The text commands generated by the input processing logic 20 in response to the inputs 22 and 24 received from the input devices 12 result in input words 18, which are text passed to the command line interface logic 16. In this way the input processing logic 20 maps input signals from a variety of input devices, that are organized into multiple input device classes, to input words 18.

The command line interface logic 16 processes the received input words 18 to generate output function calls 32, which are passed to the output processing logic 30. The output function calls may be any specific kind of function calls in any specific programming language and/or run time environment, such as, for example, function calls in the C programming language. The processing performed by the command line interface logic 16 is controlled by the text configuration files 50. The text configuration files 50 may also provide a set of words 51 to be recognized by the processing logic 20a within the input processing logic 20, in the case where processing logic 20a includes a voice recognition processor. The text configuration files 50 may further provide definitions of the function calls to be recognized 52, and that are passed to the output processing logic 30.

The controlled devices 14 may be any specific type of controllable device. The output processing logic 30 may also be embodied as processing logic blocks used to generate output signals appropriate for classes of controlled devices. For example, controlled devices contained in a class may consist of devices that are all controlled using the same type of signal or communication protocol. A class of controlled devices might include those devices that can be controlled through a common communication protocol, such as a home automation protocol, or some other type of communication protocol, while another class of controlled devices might be those devices that can be controlled using a given infrared remote control command set. Various types of home automation communication protocols may be used in this regard, including the X10 protocol, or alternatives such as INSTEON, BACnet, LonWorks, and others.

Another class of controlled devices might consist of devices that are controlled using low-frequency FM signals. Yet another example of a controlled device class might include various types of telephones, such as speakerphones. Controlled devices that are controlled through commands sent using a wireless communication protocol, such as IEEE 802.11, might be included in another output device class. The disclosed system may also be embodied to operate using a controlled device class consisting of devices controlled through a number of accessory ports, where the accessory ports include mechanical switches that can be mechanically opened or closed. Various other specific command protocols and/or signal types might alternatively and/or additionally define corresponding sets of devices considered to be within controlled device classes.

In the example of FIG. 1, the output processing logic 30 is logically divided into logic blocks that generate output commands for corresponding classes of controlled devices. Specifically, processing logic 30a for controlled device class 1 generates output commands for output devices within a first output device class, processing logic 30b for controlled device class 2 generates output commands for output devices within a second output device class, etc.

In the event that controlled device class 1 consists of devices that respond to an associated communication protocol, for example a home automation communication protocol such as the X10 protocol, the processing logic 30a would generate commands in that protocol in response to the output function calls 32. For example, devices that can be controlled using home automation protocols such as X10 include a wide variety of devices, such as lights, thermostats, doorbell chimes, fan controls, bed sheet retracting devices, and many other mechanical devices. In such an embodiment, the outputs 32 would consist of commands, such as X10 commands, each including an address identifying the controlled device to which the command is directed, such as one of controlled devices 14a, 14b, and 14c, and also including a payload portion containing a specific command to be processed by the receiving controlled device. The specific addresses needed to access specific ones of the controlled devices 14a, 14b and 14c, as well as corresponding names understood by the user for those controlled devices, would be stored in the text configuration files 50, and communicated to the command line processor 16, input processing logic 20, and output processing logic 30. In this way, the text configuration files 50 can be used to add new controlled devices, so that they can be indicated through the input devices 12 based on user understood names, and controlled through the output processing logic 30 based on their corresponding device addresses.

In the event that controlled device class 2 consists of telephone devices, the processing logic 30b would convert the output function calls 32 into commands to set up a call, configure a phone for making a call, and/or perform other phone control commands, with regard to one of the phone devices 14d or 14e. Specific phone configuration information, such as speed dial numbers, may also be contained in the text configuration files 50, and passed to the phone device 14d and/or 14e.

Where a class of output devices includes devices that are controlled through infrared signals, the corresponding logic block within the output processing logic 30 would operate to convert the output function calls 32 into infrared commands that are output to specific ones of the controlled devices 14.

The disclosed system can advantageously support new devices without upgrading or otherwise modifying the operational software image 10, so long as the new devices are contained within a class of device that is already supported by the operational software image 10. On the other hand, support for a new device in a new device class can be added through an upgrade of the operational software image 10. While it may often be desirable to avoid upgrades to the operational software image 10 when possible, the disclosed system allows such upgrades to be performed when necessary.

The input processing logic 20 and output processing logic 30 may be part of an operational software image 10 executing on one or more processors of a microprocessor based device control system, and stored in a memory or other type of program storage used to store program code executable on that processor or processors. The operational software image 10 may further include other program code 40, such as appropriate operating system software or the like, and may be made up of any specific kind or type of executable program code.

Configuration software 54, such as a Web based graphical user interface (GUI), may be provided within the operational software image 10 to generate the text configuration files 50. For example, in one embodiment, the text configuration files 50 may be generated in response to user actions such as dragging and dropping graphical representations of devices and/or individual commands into and out of a graphical representation of a current configuration of a controlling device, as facilitated through a Web based GUI. Such a Web based GUI may be provided on a local or remote computer system, and user inputs received therefrom communicated to the device control system over a communication network such as the Internet or a local area network (LAN). The configuration software 54 is not limited to being embodied as a Web based GUI, and other implementations are possible. For example, the configuration software 54 may alternatively be embodied as a compiled application program or the like executing on a local or remote computer system.

In one embodiment of the disclosed system the text configuration files 50 consist of multiple files, including one top level file indicating an order that the files are to be processed in, and multiple sub-files that are each associated with specific input device or controlled device.

During operation of the disclosed system, the text configuration files 50 may be created and/or changed in response to the configuration software 54, based on inputs from an attached communication network, and/or received from an input/output device attached to the device control system. Since all user inputs to the device control system are passed as the text input words 18 through the command line interface logic 16, and all outputs to the controlled devices 14 are controlled through the output function calls 32 generated by the command line interface logic 16, the overall behavior of the device control system can be conveniently changed in all respects by modifying or replacing all or part of the text configuration files 50, which control the operation of the command line interface logic 16, and without changing the operational software image 10, as further described below.

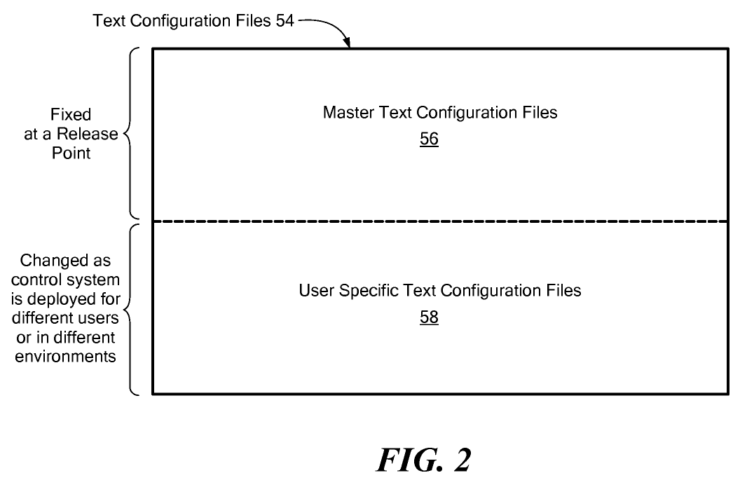

FIG. 2 is a block diagram showing an illustrative embodiment of the disclosed text configuration files. As shown in FIG. 2, the text configuration files 50 include master text configuration files 56 and user specific text configuration files 58. The master text configuration files 56 may, for example, be included in the control system when the unit is shipped. The master text configuration files 56 are user independent, and indicate the inherent functionality and/or capabilities of the control system. The master text configuration files 56 may reflect the hardware input and output interfaces of the control system, and the associated program code included in the control system to support those interfaces. The user specific text configuration files 58 are user specific, and indicate how an associated user will use the control system. For example, the user specific text configuration files 58 may indicate the specific devices that an associated user controls through the control system, the specific commands used by that user to control those devices, the order in which the devices are to be presented to that user in the user interface of the control system, and the order in which command options are to be presented to that user in the user interface of the control system.

The Master Text Configuration Files 56 and User Specific Text Configuration Files may be embodied as separate files. For example, the Master Text Configuration Files 56 may be fixed at a release point, such as release 1.0, release 1.1, release 2.0, etc. In contrast, the User Specific Text Configuration Files 58 may be changed at deployment time, such as when the control system is deployed for use by a different user, or for use in a different environment. For example, when a control system is to be used by a new or different user, the User Specific Text Configuration Files 58 may be changed to a file or set of files associated with that user, without changing the Master Text Configuration Files 56. Similarly, when a new release of the Master Text Configuration Files 56 is loaded into the control device, the User Specific Text Configuration Files 58 need not necessarily be changed. Thus the Master Text Configuration Files 56 and User Specific Text Configuration Files 58 may be advantageously embodied as independently loadable files.

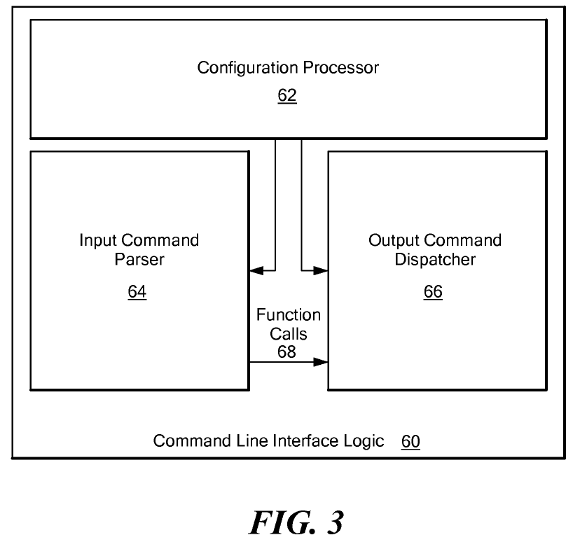

FIG. 3 is a block diagram showing the logical design of an illustrative embodiment of command line interface software logic. As shown in FIG. 2, a configuration processor 62 sets up an input command parser 64 and output command dispatcher 66. The set up operation performed by the configuration processor is performed in response to the text configuration files 50 shown in FIG. 1. The configuration performed by the configuration processor 62 defines the set of input words 18 understood and processed by the input command parser 64, as well as what steps are performed by the output command dispatcher 66 in response to each of the input words 18. After configuration, the input command parser 64 operates by issuing function calls 68 into the output command dispatcher 66.

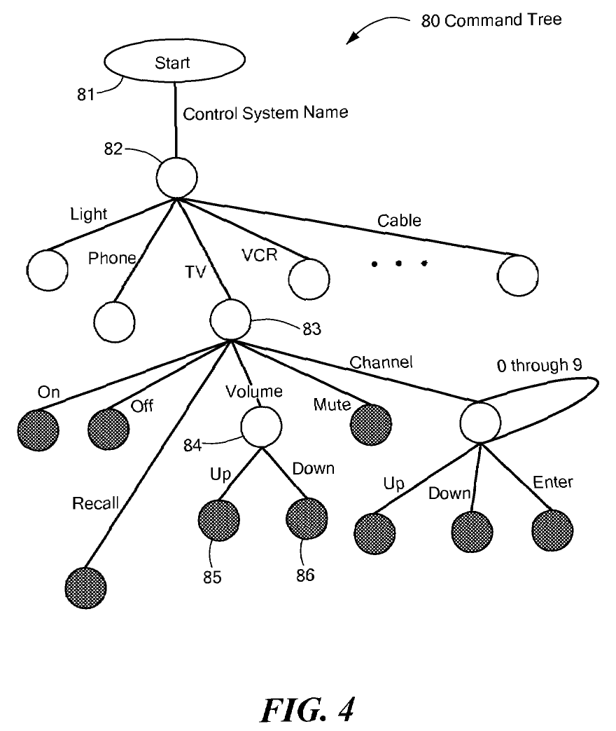

FIG. 4 shows an example of an actual command tree 80 representing processing performed by the command line interface logic 16 (FIG. 1) in response to the text configuration files 50. In the example of FIG. 4, circles that are not filled in represent intermediate nodes, while circles that are filled in represent command nodes, and an oval node 80 is the start node. Lines between nodes in the command tree 80 represent transition words received from a user. In response to transition words in the input words 18, the command line interface logic 16 (FIG. 1) changes a current node of the command tree 80. For example, after powering up the device control system, the current node of the command tree 80 is the start node 81. When the user provides the name of the control system, for example by speaking a name associated with the control system, the current node is changed to intermediate node 82. If the user then says or otherwise indicates “TV”, the current node is changed to the intermediate node 84. The control system is then able to process a number of transition words associated with a controlled television. If the user provides the transition word “volume”, then the current node is changed to intermediate node 85. At that point the user can speak or otherwise enter either “up” or “down”, and those transition words will cause the current node to be changed to command node 86 or 87 respectively. In response to the current node being changed to a command node, the command line interface logic 16 (FIG. 1) would generate an output function call 32 (FIG. 1) to the appropriate logic block within the output processing logic 30, such that an appropriate output signal or command is generated to the controlled device to cause the command associated with the command node to be performed.

For example, if the user spoke the word “up” while the current node was intermediate node 85, then the command node 86 would become the current node, and command line interface logic 16 would generate an output function call 32 that would be sent to the appropriate processing logic within the output processing logic 30 for the controlled TV, causing an output signal to be generated to the controlled TV that turns the volume setting up. Similarly, if the user spoke the word “down” while the current node was intermediate node 85, then the command node 87 would become the current node, and command line interface logic 16 would generate an output function call 32 that would be sent to the appropriate processing logic within the output processing logic 30 for the controlled TV, and that would cause an output signal to be generated to the controlled TV that caused the volume setting to be turned down.

The disclosed system may be embodied to output or present menu options to a user in an order based on the command tree 80. For example, when the current node is the intermediate node 82, the disclosed system may operate by outputting the menu options corresponding to child nodes of the intermediate node 82. For example, this may be accomplished by outputting audio prompts for such child nodes, such as “light”, “phone”, “television”, “VCR”, “cable”, etc. The user is allowed to select one of the child nodes for the current intermediate node by manipulating (opening or closing) a switch, or in some other way, during a time period following the output of the audio prompt corresponding to that child node. The prompts for the child nodes of intermediate node 82 may be output to the user in an order in which they are stored under the intermediate node 82 in the command tree 80, for example, from left to right, or from right to left. As a result, the child node menu options for intermediate node 82 in the example of FIG. 2 would be output to the user either in the order “light”, “phone”, “TV”, “VCR”, . . . “cable”, or “cable”, . . . “VCR”, “TV”, “phone”, “light”, depending on the specific embodiment.

The disclosed system advantageously enables everything under the start node 81 in the command tree 80 to be completely modifiable without having to change the operational software image of the controlling device. All that needs to be changed to change the command tree under the start node 81 is the user specific text configuration files 58 shown in FIG. 2. In this way, the disclosed system enables the transition words, such as “phone”, “TV”, “VCR”, etc., along with the intermediate and command nodes, to be conveniently re-arranged. In addition, the disclosed system provides the ability to dynamically add nodes to the command tree 80, for example during a system initialization step, so that a newly added device can be controlled. Thus a dynamic menuing system is provided that is built during initialization based on a configuration file.

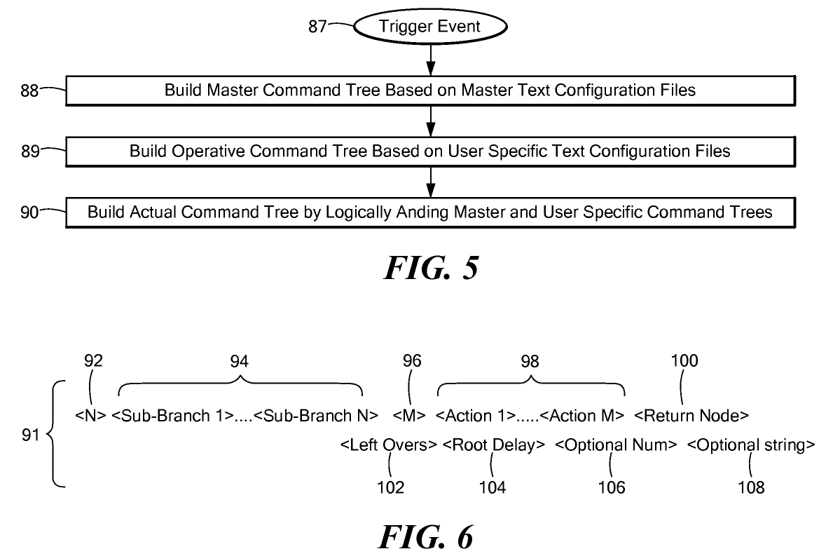

FIG. 5 is a flow chart illustrating steps performed in an illustrative embodiment of the disclosed system. As shown in FIG. 5, at step 87 a trigger even occurs, such as the booting up or powering on of the control system. Other examples of trigger events that might cause some or all of the steps shown in FIG. 5 might include the partial or complete loading or modification of the user specific text configuration files 58 shown in FIG. 2. Such a loading or modification might, for example, occur as the result of a new user beginning to use the disclosed control system, and/or a new device being connected to the control system, in order that commands associated with that device be enabled.

At step 88, the disclosed system builds a master command tree based on a set of master text configuration files. The master command tree reflects the user-independent capabilities of the disclosed control system. The disclosed system builds an operative command tree at step 89 based on a set of user specific text configuration files. The operative command tree reflects user specific controlled devices and commands. Accordingly, the operative command tree indicates which devices are controlled by an associated user, which commands are issued by that user, and the order in which the devices and commands for that user are to be presented to the user for selection by the disclosed control system.

At step 90, the disclosed system determines the intersection of the master command tree and the operative command tree by performing a logical “AND” operation on the master command tree and operative command tree. As a result, an actual command tree is created that includes only those tree nodes and/or vertices that are contained in both the master command tree and the operative command tree. The actual command tree generated at step 90 is then used by the disclosed control system to present device and associated command options to the user, for example audibly and/or through a graphical user interface, and to process commands received from the user.

The disclosed system may operate to selectively turn off user interface commands relating to a device. For example, the disclosed system may operate to turn off all commands relating to a television, VCR, or other specific type of device. In order to operate in this manner, an operative configuration tree may be built at step 89 of FIG. 5, based on user specific text configuration files, where the operative configuration tree does not include any commands relating to the device. When the operative configuration tree is combined in an “AND” operation with the master configuration tree at step 90, all commands relating to the device are omitted from the resulting actual configuration tree. Since the actual configuration tree is used to generate command menus and/or options to the user, those user interface commands relating to the device are effectively turned off and not presented as user interface options to the user.

The disclosed system may further operate to turn off individual user interface commands. For example, if a user only needs ON and OFF commands for a television controlled using the disclosed system, because channel changing commands are all performed through a cable box, then the disclosed system can be used to turn off all other commands for the television except for ON and OFF. In order to operate in this manner, an operative configuration tree may be built at step 89 of FIG. 5, based on user specific text configuration files, where the operative configuration tree does not include any commands for a controlled television other than ON and OFF. When the operative configuration tree is combined in an “AND” operation with the master configuration tree at step 90, all commands for the television other than ON and OFF are omitted from the resulting actual configuration tree. Since the actual configuration tree is used to generate command menus and/or options to the user, those user interface commands for the television other than ON and OFF are effectively turned off and not presented as user interface options to the user.

The disclosed system may further operate to re-order the presentation of commands in the user interface. For example, the disclosed system may operate to enable a user to make the command “VCR Channel_Up” the first command made available or presented within a set of related device commands, such as a menu of commands for a controlled VCR. In order to operate in this manner, an operative configuration tree may be built at step 89 of FIG. 5, based on user specific text configuration files, where the operative configuration tree has the “VCR Channel_Up” command as the first command made available or presented within a set of commands related to the controlled VCR device. When the operative configuration tree is combined in an “AND” operation with the master configuration tree at step 90, since the order of commands in the operative command tree controls the order used in the resulting actual configuration tree, the “VCR Channel_Up” command is located in the resulting actual configuration tree first within the set of commands related to the controlled VCR device. Since the actual configuration tree is used to generate command menus and/or options to the user, the “VCR Channel_Up” command is made available or presented to the user first within the set of command related to the controlled VCR. Advantageously, by re-ordering commands in this way, the user can organize menu options in a way that reduces the number of actions needed to traverse a menu in order to select a frequently used command more easily.

The disclosed system may further operate to re-order the presentation of devices for selection by the user interface. As with re-ordering of commands, a user may wish to change the order in which devices are presented for selection by the user interface. In order to operate in this manner, an operative configuration tree may be built at step 89 of FIG. 5, based on user specific text configuration files, where the operative configuration tree reflects the order in which devices are desired to be presented for selection by the user interface. When the operative configuration tree is combined in an “AND” operation with the master configuration tree at step 90, and since the order of devices in the operative command tree controls the order of devices in the resulting actual command tree, the resulting actual configuration tree reflects the desired order in which devices are presented to the user for selection in the user interface.

The disclosed system may further operate to dynamically add a new menu or command corresponding to a new device to the user interface. In order to operate in this manner, an operative configuration tree may be built at step 89 of FIG. 5, based on user specific text configuration files, where the operative configuration tree includes the new menu or command. When the operative configuration tree is combined in an “AND” operation with the master configuration tree at step 90, the new menu or command is included in the resulting actual configuration tree. Since the actual configuration tree is used to generate command menus and/or options to the user, the new menu or command is effectively turned on and presented as a user interface option to the user. In this way, a new command and/or user interface menu can be added in a convenient way, without requiring loading a completely new executable image of operational software.

FIG. 6 shows an example format for a line of the text configuration files 50 of FIG. 1, referred to herein for purposes of explanation as a “configuration entry.” To build the disclosed menuing system, the configuration processor 62 of FIG. 3 reads the text configuration files 50 from a local storage, such as a memory, and creates a command tree based on its contents. Each line in the text configuration files 50 may have the format 91 shown in FIG. 6, and describes a branch of the command tree for a corresponding command node.

With reference to FIG. 6, the element <N> 92 is a numerical value indicating the number of sub-branches of the command tree, for intermediate nodes and the command node, in the branch described by the configuration entry 91. Thus the value of <N> 92 also corresponds to the number of transition words in the branch of the command tree described by the configuration entry. For example, in the case of a configuration entry for the command node reached by the words “TV volume up” in the command tree 80 shown in FIG. 3, the value of <N> 92 would be three.

The elements <Sub-Branch 1> . . . <Sub-Branch N> 94 are text representations of the intermediate nodes and the command node in the branch of the command tree described by the configuration entry 91.

The element <M> 96 is a numerical value indicating the number of actions to be performed in the branch of the command tree described by the configuration entry. If <M> 96 is set to 0 then there will be no actions listed following it. If <M> 96 is set to 1, then one action will be listed to perform. Similarly, if <M> 96 is set to 10 there will be ten actions to perform.

The elements <Action 1> . . . <Action M> 98 represent the action or actions that the command associated with the configuration entry causes to be performed.

In one embodiment, while the command tree is dynamic, a fixed set of actions for each class of controlled devices are provided in the operational software image. For example, this fixed set of actions might include IR_Command<0-N1> for infrared controlled devices, PowerLine_Command<0-N2> for powerline communication protocol controlled devices, X10_Command<0-N3> for X10 protocol controlled devices, ContactClosure_Command<0-N4> for mechanical switch controlled devices, etc . . . Each of these fixed commands may be represented by a function that can be looked up in a function table. Thus, in the case of the fixed infrared commands IR_Command<0-N 1>, new infrared signals could be learned by the controlling device and related to a menu for the new device. Multiple actions can be chained together on a branch. All of the specified actions will always be added to and performed in response to the Nth node of the branch, which is the command node.

The <Return Node> element 100 indicates whether the current node stays the same after an action is performed. For example, <Return Node> 100 may be an unsigned 8 bit value that can range from 0 to 255. When <Return Node> 100 is set to 0, the current node of the command tree stays at the same node after the disclosed system performs any of the actions associated with branches of the command tree. When <Return Node> 100 is set to 255, the disclosed system returns to the root of the command tree after it performs actions for a given branch. When <Return Node> 100 is set to any value of 1 to 254 the disclosed system walks back up the command tree the indicated number of nodes after it performs an action.

The <Left Overs> 102 indicates whether there are text characters at the end of the configuration entry. For example, this field may be used to allow information such as a filename to be passed to commands that are used to a the file system.

The <Root Delay> 104 provides a way to place a generic timeout on every command in the system. In one embodiment, <Root Delay> 104 is an unsigned 16 bit value that can range from 0 to 65535. When set to 0 the <Root Delay> 104 will be ignored. When set to any other value the timeout will be engaged, and once the command for the configuration entry has executed and returned to the return node that was specified, the disclosed system waits at that node the number of seconds indicated by <Root Delay> 104. Once that time has expired, the system times out, and returns to the root node of the command tree.

The <Optional Num> 106 and <Optional String> 108 are command specific values that may be provided as needed.

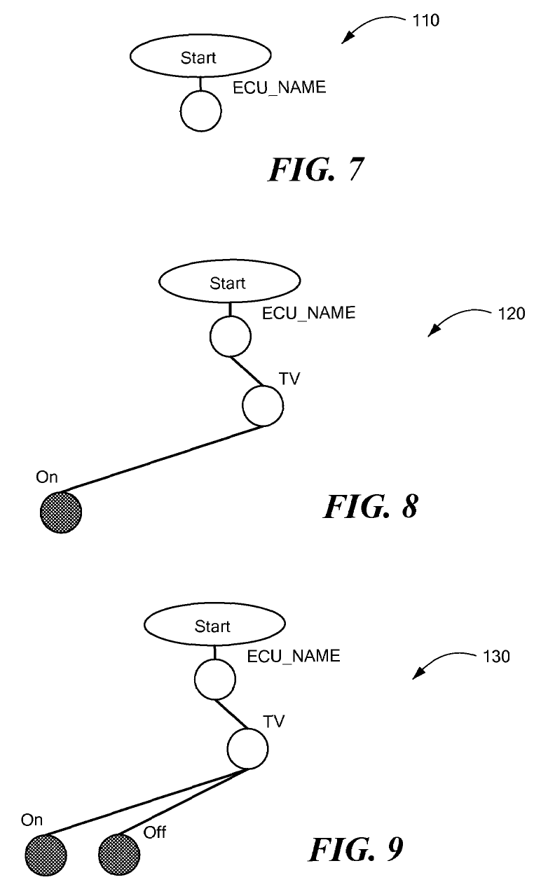

FIGS. 7-18 are command tree diagrams showing an example of a master command tree being constructed using an illustrative embodiment, for example based on the master text configuration files 56 of FIG. 2. In these figures, a possible series of steps for creating the TV command branch structure in the command tree of FIG. 4 is shown. After each configuration entry is processed, a figure illustrating the resulting command tree is provided. FIG. 7 shows the command tree 110 before any configuration entries have been processed. FIG. 8 shows the command tree 120 resulting after the following configuration entry has been processed:

| | |
|---|---|
| 2 tv on | 1 ir_command0 1 0 60 0 0 |

FIG. 9 shows the command tree 130 resulting after the following configuration entry has been processed:

| | |
|---|---|
| 2 tv off | 1 ir_command1 1 0 60 0 0 |

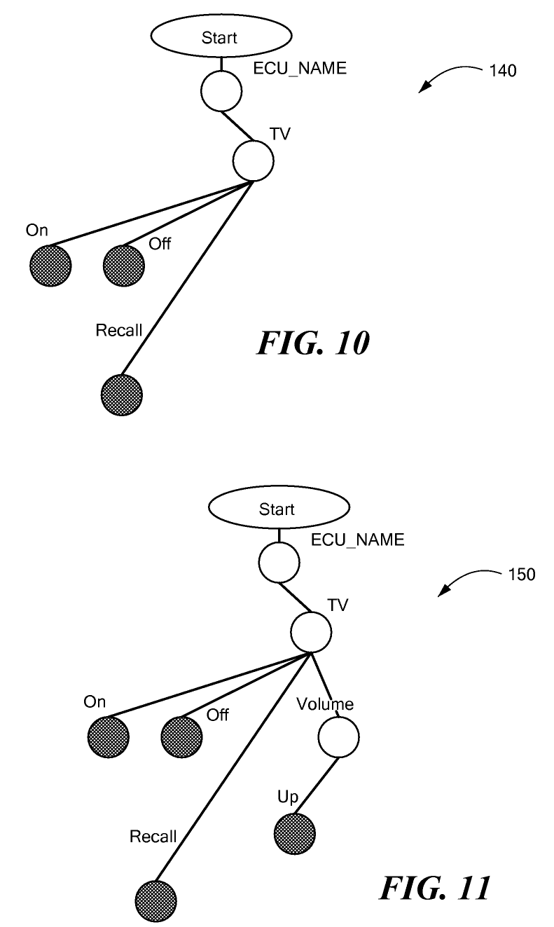

FIG. 10 shows the command tree 140 resulting after the following configuration entry has been processed:

| | |
|---|---|
| 2 tv recall | 1 ir_command2 1 0 60 0 0 |

FIG. 11 shows the command tree 150 resulting after the following configuration entry has been processed:

| | |
|---|---|
| 3 tv volume up | 1 ir_command3 1 0 60 0 0 |

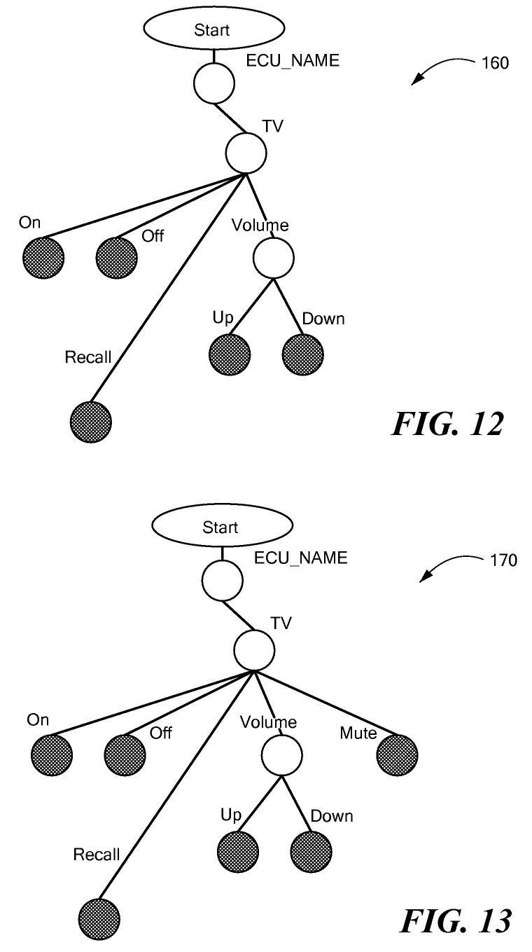

FIG. 12 shows the command tree 160 resulting after the following configuration entry has been processed:

| | |
|---|---|
| 3 tv volume down | 1 ir_command4 1 0 60 0 0 |

FIG. 13 shows the command tree 170 resulting after the following configuration entry has been processed:

| | |
|---|---|
| 2 tv mute | 1 ir_command5 1 0 60 0 0 |

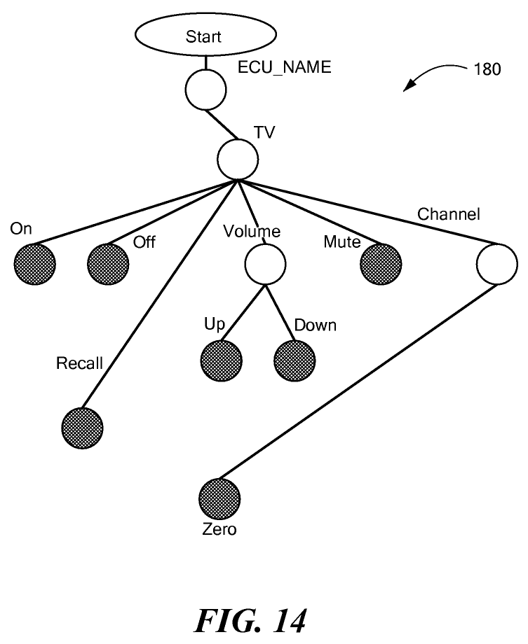

FIG. 14 shows the command tree 180 resulting after the following configuration entry has been processed:

| | |
|---|---|
| 3 tv channel zero | 1 ir_command8 1 0 60 0 0 |

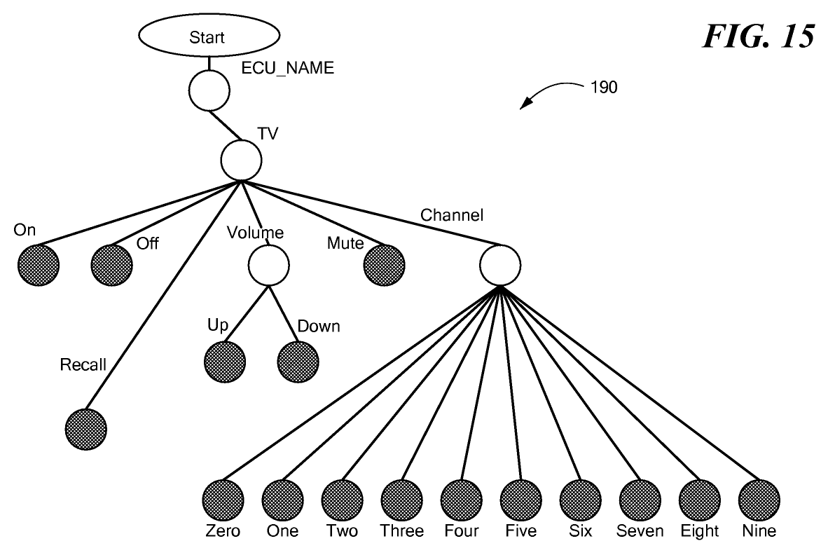

FIG. 15 shows the command tree 190 resulting after processing configuration entries for channels one through nine, including the following entry for channel nine:

| | |
|---|---|
| 3 tv channel nine | 1 ir_command18 1 0 60 0 0 |

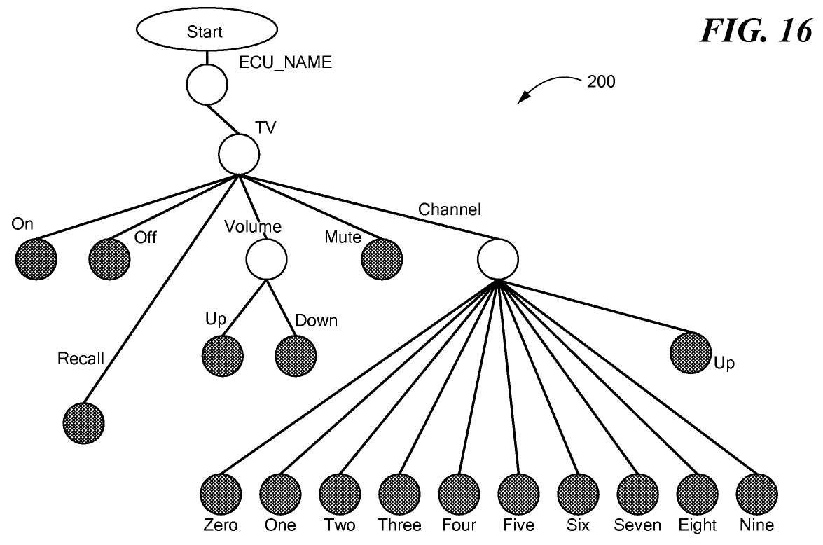

FIG. 16 shows the command tree 200 resulting after the following configuration entry has been processed:

| | |
|---|---|
| 3 tv channel up | 1 ir_command6 1 0 60 0 0 |

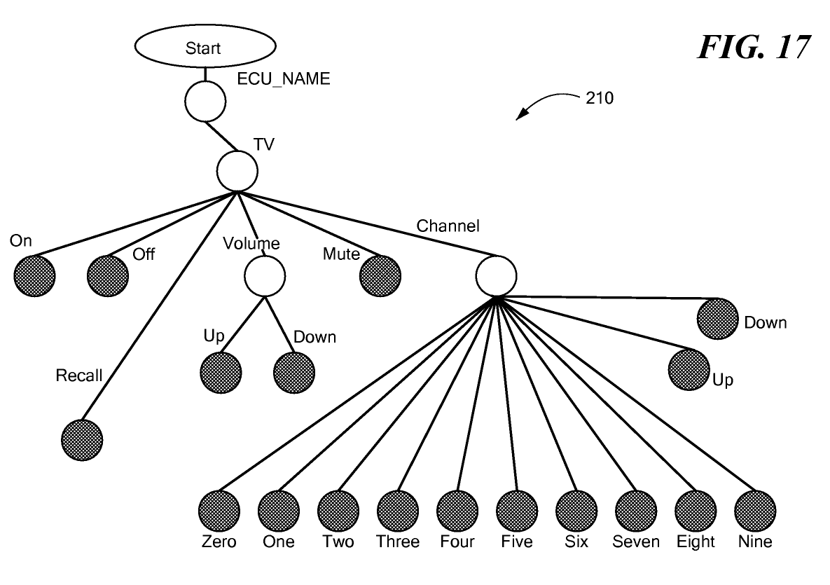

FIG. 17 shows the command tree 210 resulting after the following configuration entry has been processed:

| | |
|---|---|
| 3 tv channel down | 1 ir_command7 1 0 60 0 0 |

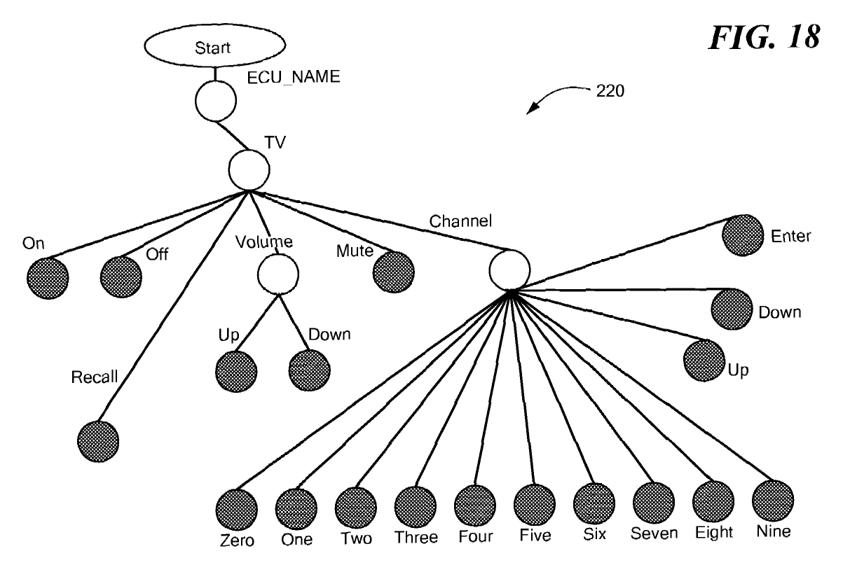

FIG. 18 shows the command tree 220 resulting after the following configuration entry has been processed:

| | |
|---|---|
| 3 tv enter | 1 ir_command19 1 0 60 0 0 |

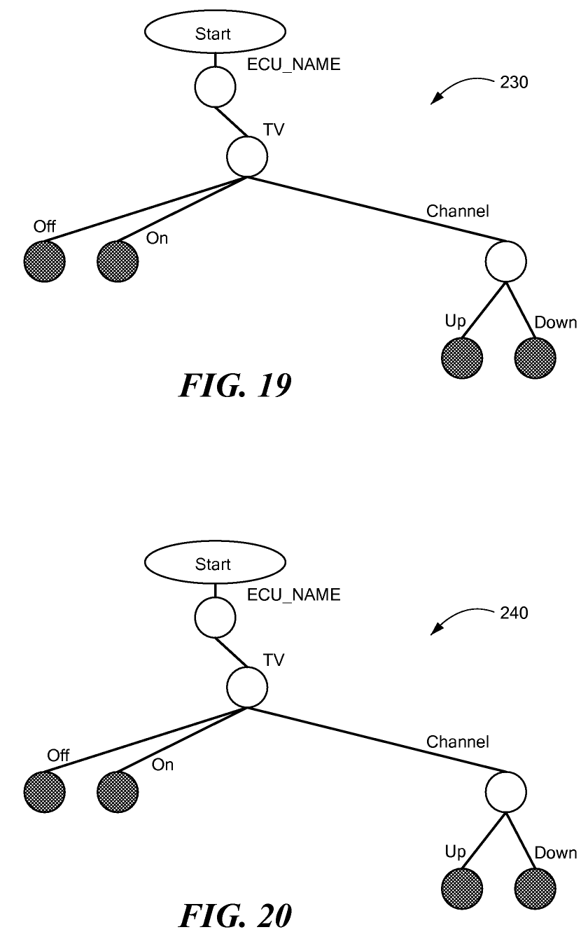

FIG. 19 shows an example of an operative command tree 230 reflecting user specific command configuration information. For example, the operative command tree 230 may be formed based on the user specific configuration files 58 shown in FIG. 2. FIG. 20 shows an example of an actual command tree 240 formed as a result of performing a logical “AND” operation between the master command tree 220 of FIG. 18 and the operative command tree 230 of FIG. 19. The actual command tree 240 only includes those command tree components that are contained in both the master command tree 220 and the operative command tree 230. Thus the actual command tree 240 reflects the intersection of the master command tree 220 and the operative command tree 230. Moreover, the order and/or arrangement of the command tree components in the actual command tree 240 reflect the order and/or arrangement of the command tree components in the operative command tree 230. Accordingly, since the order in which commands are presented to the user is based on the actual command tree 240, the user is provided with a user interface experience that reflects the user specific operative command tree 230.

The figures include block diagrams and a flowchart illustration of methods, apparatus(s) and computer program products according to an embodiment of the invention. It will be understood that each block of the block diagrams and/or flowchart, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program command structures, one skilled in the art will recognize that they may be embodied using a variety of specific command structures.

1. A method of providing dynamically configurable and extensible control of devices through a control system, comprising:
generating a command tree in response to at least one text configuration file; and
using said command tree by a command line interface to process input words received from a user to generate output function calls that cause corresponding output signals to be sent to at least one device controlled by said user through said control system.

2. The method of claim 1, further comprising:
wherein said at least one text configuration file includes at least one user independent master text configuration file including at least one user independent configuration entry indicating the functional capabilities of said control system; and
wherein said at least one text configuration file further includes at least one user specific text configuration file associated with said user and including at least one user dependent configuration entry indicating at least one user specific configuration.

3. The method of claim 2, wherein said functional capabilities of said control system reflect the devices said control system is capable of controlling.

4. The method of claim 3, wherein said at least one user specific configuration comprises at least one command to be used by said user to control said at least one device controlled by said control system.

5. The method of claim 4, wherein said at least one user specific configuration comprises an ordering of commands to be presented to said user for selection by said user.

6. The method of claim 5, further comprising:
generating a master command tree based on said master text configuration files;
generating an operative command tree based on said user specific text configuration files;
performing a logical “AND” operation on said master command tree and said operative command tree to generate an actual command tree containing only command tree elements present in both said master command tree and said operative command tree; and
using said actual command tree by said control system to present command options to said user and to process commands received from said user.

7. The method of claim 1, wherein said control system comprises an environmental control unit.

8. A control system including a computer readable medium, said computer readable medium having program code stored thereon for providing dynamically configurable and extensible control of devices through said control system, said program code comprising:
program code for generating a command tree in response to at least one text configuration file; and
program code for using said command tree by a command line interface to process input words received from a user to generate output function calls that cause corresponding output signals to be sent to at least one device controlled by said user through said control system.

9. The control system of claim 8, further comprising:
wherein said at least one text configuration file includes at least one user independent master text configuration file including at least one user independent configuration entry indicating the functional capabilities of said control system; and
wherein said at least one text configuration file further includes at least one user specific text configuration file associated with said user and including at least one user dependent configuration entry indicating at least one user specific configuration.

10. The control system of claim 9, wherein said functional capabilities of said control system reflect the devices said control system is capable of controlling.

11. The control system of claim 10, wherein said at least one user specific configuration comprises at least one command to be used by said user to control said at least one device controlled by said control system.

12. The control system of claim 11, wherein said at least one user specific configuration comprises an ordering of commands to be presented to said user for selection by said user.

13. The control system of claim 12, said program code further comprising:
program code for generating a master command tree based on said master text configuration files;
program code for generating an operative command tree based on said user specific text configuration files;
program code for performing a logical “AND” operation on said master command tree and said operative command tree to generate an actual command tree containing only command tree elements present in both said master command tree and said operative command tree; and
program code for using said actual command tree by said control system to present command options to said user and to process commands received from said user.

14. The control system of claim 8, wherein said control system comprises an environmental control unit.

15. A system for providing dynamically configurable and extensible control of devices through said control system, comprising:
means for generating a command tree in response to at least one text configuration file; and
means for using said command tree by a command line interface to process input words received from a user to generate output function calls that cause corresponding output signals to be sent to at least one device controlled by said user through said control system.
